(19) United States
(12) Patent Application Publication
(10) Pub. No.: US 2024/0015394 A1
(43) Pub. Date: Jan. 11, 2024

(54) Camera and Hub Arrangement

(71) Applicant: Ubiquiti Inc., New York, NY (US)

(72) Inventors: Tsung-Hwa Yang, New York, NY (US); Hong Wei Lin, New York, NY (US); Chi-Shen Wang, New York, NY (US); Pai-Chen Sun, New York, NY (US); Yong-Ruei Yang, New York, NY (US); Chung-Ming Lo, New York, NY (US); Yue-Lin Han, New York, NY (US)

(21) Appl. No.: 18/219,223

(22) Filed: Jul. 7, 2023

Related U.S. Application Data
(60) Provisional application No. 63/358,925, filed on Jul. 7, 2022.

(51) Int. Cl. H04N 23/65; H04N 23/80; H04N 23/63; H04N 23/661; H04N 23/50

(52) U.S. Cl. CPC H04N 23/65; H04N 23/80; H04N 23/633; H04N 23/661; H04N 23/50; F16M 13/02

(57) ABSTRACT

Example camera and hub arrangements are presented herein. An example device includes an Ethernet connector configured to provide power and data, a camera port configured to provide power and data to a camera module, and an audio port configured to provide power and data to at least one audio input/output module. The device also includes a processor configured to determine one or more camera parameters for the camera module attached to the camera port, such as a type of a camera module attached to the camera port. The device can change operation mode based on camera parameters and audio parameters associated with connected camera modules and audio modules. Different modules can be connected to the device and located remotely from the device.

### CROSS-REFERENCE TO RELATED APPLICATION

The present disclosure claims priority to U.S. Provisional Application No. 63/358,925, filed on Jul. 7, 2022, the entire contents of which are herein incorporated by reference.

### BACKGROUND

Modern user premises, such as homes, offices, restaurants, or hotels, are often equipped with internet-connected computing devices such as personal computers, smartphones, wearable devices, security systems, appliances, lights, power outlets, and speakers. These computing devices are typically capable of engaging in data communication over a network. In the specific case of security systems, cameras can be placed indoors and/or outdoors on walls, ceilings, or other structures to monitor activity in those areas, such as people, vehicles, pets, etc.

### SUMMARY

In one aspect, a device is described. The device includes an Ethernet connector configured to provide power and data, a camera port configured to provide power and data to a camera module, and an audio port configured to provide power and data to at least one audio input/output module. The device also includes a processor configured to determine one or more camera parameters for the camera module attached to the camera port. The one or more camera parameters include a type of a camera module attached to the camera port.

In another aspect, a method is described. The method involves determining, by a processor coupled to a device, one or more camera parameters for a camera module attached to a camera port. The device includes the camera port configured to provide power and data to the camera module. The method further involves changing, by the processor, operational modes based on the determined one or more camera parameters of the camera module attached to the camera port and determining, by the processor, one or more audio device parameters for an audio input/output module attached to an audio port. The device includes the audio port configured to provide power and data to the audio input/output module. The method also involves changing, by the processor, operational modes based on the determined one or more audio device parameters of the audio input/output module attached to the audio port.

In an additional aspect, a non-transitory computer-readable medium is described. The non-transitory computer-readable medium is configured to store instructions, that when executed by a device, causes the device to perform operations, such as the operations of the method described above.

Other aspects, embodiments, and implementations will become apparent to those of ordinary skill in the art by reading the following detailed description, with reference where appropriate to the accompanying drawings.

### BRIEF DESCRIPTION OF THE DRAWINGS

FIG. 1 is a block diagram of a device, according to one or more example embodiments.

FIG. 2 illustrates a front surface of a device configured with a display, according to one or more example embodiments.

FIG. 3 illustrates various views of the device, according to one or more example embodiments.

FIG. 4 illustrates camera modules, audio modules, and mounts, according to one or more example embodiments.

FIG. 5A illustrates types of camera modules, according to one or more example embodiments.

FIG. 5B further illustrates the types of camera module, according to one or more example embodiments.

FIG. 6A illustrates camera modules, audio modules, and mounts for such modules, including views depicting how such modules are connected to the mounts.

FIG. 6B illustrates a camera mount with angle adjustability for use with a camera module, according to one or more example embodiments.

FIG. 7 is a flowchart of a method for adjusting operations, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Example embodiments relate to devices that interface with physically separate camera modules and audio modules and techniques for using the devices. Such devices enable camera modules and audio modules to be positioned physically separate from the devices, which allows for unique placement of the module or modules on walls, ceilings, and other positions within an environment. This allows a camera module or audio module to be hidden mostly within a ceiling or wall while the device processing the image data or audio data is positioned at another location, which can increase the aesthetic appearance of the camera or audio installation. An example device can provide the compute and control for one or multiple attachable modules, such as one or more camera modules and/or audio modules. Each module can be positioned remotely from the device and connected via one or multiple cables.

Some examples relate to an improved security camera device (hereinafter referred to as “the device,” for brevity) that has an Ethernet connector, a camera port, an audio port, and a processor. The Ethernet connector can be configured to provide power and data, thus providing power over Ethernet (POE) to the device. The camera port can be configured to provide power and data to a camera module, as well as facilitate two-way communication between the processor and the camera module. The audio port is configured to provide power and data to at least one audio input/output module (hereinafter referred to as “audio module,” for brevity), as well as facilitate two-way communication between the processor and the audio module. In some cases, the audio port can be configured to provide audio signals to a speaker and receive audio signals from a microphone. Further, the processor can be configured to perform various operations, including but not limited to determining one or more camera parameters for the camera module attached to the camera port and performing certain actions depending on the determined camera parameter(s).

In some cases, such as when visibility of the device is less desirable, the device can be mounted in a through-wall (or through-ceiling) installation such that only a lens of the camera is visible. Alternatively, the device can be mounted using a small mount (e.g., a mount having a low profile protruding from the wall or ceiling). In some cases, the small mount can be an angle mount that keeps the camera module angled at a particular angle (e.g., 45 degrees) and might or might not allow for the camera module to swivel, or the small mount can be a free angle mount that allows the camera module to swivel and move between multiple different angles.

Within examples, the camera module can be any of a plurality of different types of camera modules, such as a wide angle lens camera, a telephoto lens camera, and a fisheye lens camera, among other possibilities. The determined camera parameter(s) can include the type of camera module, as discussed above. The camera parameter(s) can also include, for example, a resolution, field of view, manufacturer, a camera module identification string, and whether the camera module has night vision capabilities, among other possibilities.

Within examples, the audio module can be any of a plurality of different types of audio input devices and/or audio output devices, such as, generally, a speaker, a microphone, or a speaker with an integrated microphone, among other possibilities. For a microphone, audio module parameters can include, for instance, (i) whether the microphone is omnidirectional, unidirectional, or cardioid, (ii) whether the microphone is wide-band, (iii) a sensitivity level of the microphone, (iv) a manufacturer of the microphone, and/or (v) a signal-to-noise ratio of the microphone. For a speaker, audio module parameters can include, for instance, a speaker shape (e.g., single circular), a manufacturer of the speaker, a resonant frequency, and/or a max loudness.

Within examples, the device can also include a display screen configured to display a variety of information related to the device and modules connected thereto. For example, the display screen can be configured to display camera information for a camera module coupled to the camera port (e.g., the determined camera parameter(s)), a data rate of data communicated from the device by way of the Ethernet connector, a data rate of data communicated from the device by way of the camera module coupled to the camera port, information related to audio captured by a microphone coupled to the audio port (e.g., the relative volume of sound captured by the microphone), and/or information related to audio commuted to a speaker by way of the audio port. Moreover, the display screen may also be configured to display a data rate of an Ethernet connection of the main hub. In addition, the device can be controlled remotely by a user via an application or a web-based interface.

In some cases, it can be desirable to reduce the bulkiness and visibility of security systems. In line with the discussion above, for instance, at least a portion of the device (e.g., at least the camera module) can be mounted in a through-wall (or through-ceiling) installation with only the lens being visible, as described in more detail later herein. In some examples, the camera module may be generally cylindrically shaped with a diameter between 22 and 30 mm and a length between 43 and 47 mm.

Additionally, to further reduce bulkiness and visibility, the camera module can be located at a separate location from the main hub of the device (e.g., a main housing that includes the processor, ports, and possibly other components), such as 10 to 30 meters away from the main hub. As such, within examples, the camera port can be operable to power a camera module over a distance of at least 10 meters.

Within examples, the device (e.g. the main hub of the device) can include more than one camera port, such as a second camera port, totaling two camera ports, or a second, third, and fourth camera port, totaling four camera ports. Within other examples, the device can include more than one audio port. In these examples, each of the camera ports may function in a similar manner to the examples described with respect to the single camera port examples.

Within examples, any one or more of the camera port(s) and/or the audio port(s) can take the form of a Universal Serial Bus (USB) port, such as a USB Type-C port. As a specific example, the camera port can include a plurality of pins, where each pair of four pairs of pins include an I3C or MIPI® data bus. The plurality of pins may enable high-speed data communication between the camera module and the device. Therefore, processing of images captured by the camera may be processed by the device rather than at the camera module itself. Moreover, as previously described, the camera module may be located some distance from the device, the USB port may provide electrical power sufficient to power the camera modules so that the camera module does not need another source of electrical power.

In line with the discussion above, the main hub may be powered by way of POE from an Ethernet cable connected to the main hub. Further, in some examples, the main hub may also be in communication with a Network Video Recorder (NVR) device. The NVR may control and record from one or more cameras and/or main hubs in communication with the NVR. In some further examples, the main hub may include a wireless connection (e.g., 802.11-family of wireless connections, such as 802.11ax or 802.11ax). The main hub may be powered by way of the POE connection and communicate data to an NVR by way of the wireless connection. Within examples, a processor of the device may perform compression and/or other image processing on images and video captured by the camera module and communicate the processed image and/video to the NVR for storage.

Additionally, a camera system may have a user interface (e.g., an application or web based interface) that enables a user to adjust parameters of camera recording. A user may specify zones within a camera image for motion detection. In some examples, the user may additionally specify zones within a camera image for object detection, such as vehicle, person, animal, package etc. In some yet further examples, a user may specify a threshold in an image, such as a store entryway and the camera may detect when an object crosses the threshold. Additional detection modes, such as face detection and license plate detection may also be possible.

Within examples, the processor can be configured to access, from local memory or remote memory (e.g., a server database), a respective profile associated with a particular one of the different types of camera modules that are compatible with the device. For example, when a camera module is first plugged into the camera port, the processor will either select an existing predefined profile associated with the camera module, or a user can be prompted on a user interface (e.g., of the device itself, or on a smartphone of the user via a software application associated with the device) to provide various information that together defines the profile for the camera module. The information in a profile can include, for instance, the user-specified zones discussed above and/or other user preferences (e.g., camera zoom levels, lighting and/or color correction preferences, lens distortion preferences, etc.). If the user creates the profile, the profile can be stored in local or remote memory by the processor, or can be pushed to local or remote memory for the device from the user's smartphone or other computing device. The processor can then perform actions in accordance with the profile when the camera module is connected.

In the event that the camera module is switched out for another, different camera module, the processor can select, from memory, a predefined profile associated with that new camera module, or can similarly prompt the user to define the profile as discussed above.

Upon detecting that a camera module or audio module has been coupled to the camera port or audio port, respectively, the processor can be configured to detect one or more parameters associated with that camera module and/or audio module and use those parameters to select a corresponding profile for that camera module and/or audio module.

Additionally or alternatively, there can be respective profiles associated with different audio modules as well, which are predefined or newly defined by a user in the same way as discussed above with respect to profiles for camera modules. For an audio module, information in the profile can include enabling or disabling a speaker and/or microphone of the audio module, adjusting beamforming capabilities of a speaker and/or microphone, adjusting an output volume of a speaker, adjusting a gain of microphone, adjusting array capabilities of a speaker and/or microphone.

In some examples, a profile may include a plurality of camera modules and/or audio modules and specify their associated operational parameters. In one example, adding a second speaker may enable a stereo profile that allows the capture and/or transmission of two-channel audio.

In line with the discussion above, the device can support hot swapping of various camera modules and/or audio modules. That is, the processor can be configured to keep the device running (e.g., keep a camera-specific and/or audio-specific process running) while a camera module is swapped out for another, and/or while an audio module is swapped out for another.

Within examples, the camera port can be a hot swap camera port including a camera bus and a power line. Within other examples, the audio port can be a hot swap audio port including a camera bus and a power line.

Within examples, when a camera module and/or audio module are connected to the device, the device may also perform an authentication procedure to determine if the connected camera module and/or audio module is a known module. For example, the device may determine a manufacturer of the camera module and/or audio module and only enable operation of the camera module and/or audio module if the manufacturer matches a predetermined one or more manufacturers. In another example, the device may ensure that a connected camera module and/or audio module includes a cryptographic key before enabling the camera module and/or audio module. The forgoing procedures may be used to prevent tampering with a camera system.

The processor switching profiles when camera modules and/or audio modules are swapped out is one example of how the processor can change operational modes based on the determined camera parameter(s) and/or determined audio parameter(s). As a general matter, to change operational modes based on determined module parameters, the processor can use mapping data (e.g., stored in local or remote memory) that maps each of a plurality of operational modes of the device (e.g., profiles and corresponding instructions for operating the device in accordance with each profile) to a corresponding respective set of one or more parameters, to select an operational mode that the mapping data maps to the determined one or more parameters. The processor can then perform actions in accordance with the selected operational mode.

As discussed above, the device can be mounted by way of a through-wall mount. To facilitate this, the through-wall mount can include (i) a device-holding portion configured to be disposed within the wall and house at least a portion of the device (e.g., the camera module) within the wall such that the device is accessible and visible from an exterior surface of the wall and (ii) a support portion configured to attach to an interior of the wall. In some cases, the through-wall mount can be configured to facilitate mounting of the device to the wall such that an exterior surface of the device is substantially flush with the exterior surface of the wall. Alternatively, the through-wall mount can function as a through-ceiling mount.

Within examples, the device can also provide controls to a module to adjust the orientation or state of the module. For instance, the device can provide instructions to a camera module that trigger the camera module to change field of view, apply a zoom in or zoom out feature, and/or alter position of the camera lens relative to the mount, etc. In some cases, the camera module and/or the mount holding the camera module may include one or more motors that enable the camera to be repositioned, and/or extended and/or retracted, etc. The device can provide instructions that similarly adjust a position of a speaker or a microphone. For instance, the audio module and mount can include one or more motors that enable the speaker or microphone to be repositioned, and/or extended or retracted, etc.

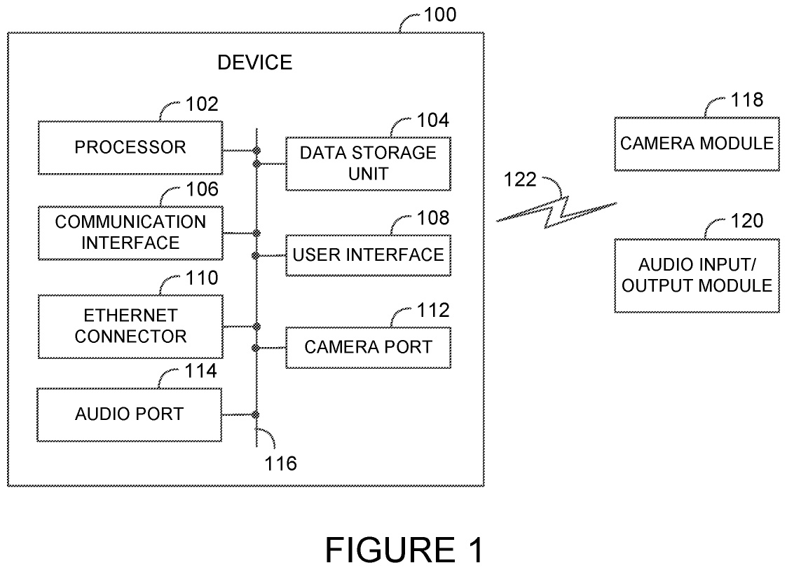

Referring now to the figures, FIG. 1 is a simplified block-diagram of device 100 that can perform various acts and/or functions, such as those described in this disclosure. Device 100 can include various components, such as processor 102, data storage unit 104, communication interface 106, user interface 108, Ethernet connector 110, camera port 112, and/or audio port 114. In addition, FIG. 1 shows device 100 connected to camera module 118 and audio input/output module 120, which can be located as part of device 100 in some examples and external to device 100 in other examples.

These components as well as other possible components can connect to each other (or to another device, system, or other entity) via connection mechanism 116, which represents a mechanism that facilitates communication between two or more devices, systems, or other entities. As such, connection mechanism 116 can be a simple mechanism, such as a cable or system bus, or a relatively complex mechanism, such as a packet-based communication network (e.g., the Internet). In some instances, a connection mechanism can include a non-tangible medium (e.g., where the connection is wireless).

Processor 102 may correspond to a general-purpose processor (e.g., a microprocessor) and/or a special-purpose processor (e.g., a digital signal processor (DSP)). In some instances, device 100 may include a combination of processors.

Data storage unit 104 may include one or more volatile, non-volatile, removable, and/or non-removable storage components, such as magnetic, optical, or flash storage, and/or can be integrated in whole or in part with processor 102. As such, data storage unit 104 may take the form of a non-transitory computer-readable storage medium, having stored thereon program instructions (e.g., compiled or non-compiled program logic and/or machine code) that, when executed by processor 102, cause the device 100 to perform one or more acts and/or functions, such as those described in this disclosure. Device 100 can be configured to perform one or more acts and/or functions, such as those described in this disclosure. Such program instructions can define and/or be part of a discrete software application. In some instances, device 100 can execute program instructions in response to receiving an input, such as from communication interface 106 and/or user interface 108. Data storage unit 104 may also store other types of data, such as those types described in this disclosure.

Communication interface 106 can allow device 100 to connect to and/or communicate with another entity according to one or more protocols. In an example, communication interface 106 can be a wired interface, such as an Ethernet interface or a high-definition serial-digital-interface (HD-SDI). In another example, communication interface 106 can be a wireless interface, such as a cellular or WI-FI interface. A connection can be a direct connection or an indirect connection, the latter being a connection that passes through and/or traverses one or more entities, such as a router, switcher, or other network device. Likewise, a transmission can be a direct transmission or an indirect transmission.

User interface 108 can facilitate interaction between device 100 and a user of device 100, if applicable. As such, user interface 108 can include input components such as a keyboard, a keypad, a mouse, a touch sensitive panel, a microphone, and/or a camera, and/or output components such as a display device (which, for example, can be combined with a touch sensitive panel), a sound speaker, and/or a haptic feedback system. More generally, user interface 108 can include hardware and/or software components that facilitate interaction between device 100 and the user of the computing device system. In some examples, user interface 108 can provide audio, tactile, and/or visual communications that help guide a user through steps that enable device 100 to be installed or change operations.

Ethernet connector 110 represents one or more Ethernet connection points that device 100 may include. Also known as an Ethernet port or Ethernet jack, Ethernet connector 110 is a hardware interface on device 100 that enables device 100 to connect to a local area network (LAN) using Ethernet cables. As such, Ethernet connector 110 and Ethernet cables provide a standard interface used for wired network connectivity. Ethernet connectors are typically rectangular in shape and feature a small opening into which an Ethernet cable with an RJ-45 connector can be inserted. The RJ-45 connector has eight pins that align with the corresponding pins in the Ethernet port. When the cable is plugged in, these pins make electrical contact with the port, establishing a physical connection.

In general, Ethernet connector 110 serves as a communication pathway between device 100 and the network by facilitating the transmission and reception of data packets between device 100 and other devices on the network. The Ethernet port operates according to the principles of the Ethernet protocol, which defines the rules for transmitting and receiving data over a network. Once a device is connected to an Ethernet port, it can send and receive data using Ethernet frames. These frames are packaged units of data that contain the source and destination addresses, as well as the actual data being transmitted. Ethernet connector 110 handles the electrical signals necessary to transmit these frames over the Ethernet cable, which is usually twisted pair copper wiring. As such, Ethernet connectors support various Ethernet standards, such as 10BASE-T, 100BASE-TX, and 1000BASE-T. These standards define the speed and other specifications of the Ethernet connection. For example, 10BASE-T supports data transfer rates of up to 10 Mbps, while 1000BASE-T (also known as Gigabit Ethernet) supports speeds of up to 1 Gbps.

Camera port 112 refers to a hardware interface specifically designed for connecting one or more camera modules (e.g., camera module 118) to device 100. Camera port 112 is a dedicated connector that allows the device to interface with a camera and capture images or videos. The specific type of camera port can vary depending on the device and its intended use.

The configuration of camera port 112 can differ within examples. For instance, camera port 112 can be Mobile Industry Processor Interface (MIPI) Camera Serial Interface (CSI), which is a standardized interface that enables the direct connection of a camera module to processor 102 or other components (e.g., system-on-a-chip (SoC)). The MIPI CSI interface supports high-speed data transfer between camera module 118 and device 100, thereby facilitating efficient image and video capture.

To connect camera module 118 to device 100 via camera port 112, camera module 118 can be designed with a corresponding connector. The camera module connector, often referred to as the camera module socket or camera flex connector, is specifically designed to mate with camera port 112 on device 100. The camera module connector typically features a specific number of pins or contacts that match the corresponding pins or contacts on camera port 112. These pins establish the necessary electrical connections between camera module 118 and device 100. They transmit power, data, and control signals between camera module 118 and processor 102 or SoC of device 100. As such, when camera module 118 is connected to device 100 via camera port 112, it allows software and hardware of device 100 to communicate with camera module 118. Device 100 can send commands and receive data from camera module 118, which enables various functions, such as image capture, video recording, autofocus control, and other camera-related features. In some cases, camera port 112 and camera module 118 can have different specifications and standards, depending on device 100 and its intended application. For example, different devices may support different resolutions, frame rates, and sensor types.

Audio port 114 is another component on device 100. Also known as an audio jack or audio connection, audio port 114 is a hardware interface that allows for the connection of audio input/output devices (e.g., audio input/output module 120) to device 100. As such, audio port 114 enables the transmission of audio signals between device 100 and external audio equipment, such as headphones, speakers, microphones, or other audio devices.

In some embodiments, audio port 114 consists of a round or rectangular socket on device 100 into which a compatible audio plug is inserted. For instance, a common type of audio port is the 3.5 mm (⅛ inch) audio jack, also known as a headphone jack or aux jack. Other types of audio ports, such as RCA, optical, or HDMI, may be used on device 100. To connect audio input/output module 120 to device 100 via audio port 114, an audio cable or connector that matches both audio port on device 100 and audio input/output module 120. For example, when device 100 has a 3.5 mm audio port, a cable with a 3.5 mm audio plug on both ends can be used. When the audio plug is inserted into audio port 114, an electrical connection between device 100 and audio input/output module 120 is established. This connection allows for the transmission of analog or digital audio signals between device 100 and audio input/output module 120. As such, audio port 114 can be designed to support both audio input and audio output. As an example result, devices such as headphones or speakers can be connected to audio port 114 to provide audio generated by device 100. Additionally, external microphones or other audio input devices to audio port 114 to capture audio input.

In some embodiments, the specific functionality and compatibility of audio port 114 may vary depending on device 100 and its audio capabilities. Some devices may support stereo audio output, while others may support surround sound. Some devices may have dedicated audio input ports for microphone input or line-in audio. Additionally, devices such as smartphones or tablets may combine the audio port with other functions, such as charging or data transfer, in a single connector (e.g., USB-C).

Connection mechanism 116 may connect components of device 100. Connection mechanism 116 is illustrated as a wired connection, but wireless connections may also be used in some implementations. For example, connection mechanism 116 may be a wired serial bus such as a universal serial bus or a parallel bus. A wired connection may be a proprietary connection as well. Likewise, connection mechanism 116 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, LTE, or 5G), or Zigbee® technology, among other possibilities.

Camera module 118, also known as an image sensor module or camera sensor, represents one or multiple self-contained unit(s) that integrate various components to capture images or video. For instance, camera module 118 can be a compact module that includes an image sensor, lens, and supporting circuitry necessary for image capture and processing. Camera module 118 can work by utilizing the image sensor for converting light into electrical signals. When light enters camera module 118 through the lens, the light falls onto the image sensor's photosensitive elements, such as pixels or photosites. The image sensor then converts the light into electrical signals that represent the captured image. Camera module 118 can also include additional circuitry and components to support the image sensor's functionality. These may include analog-to-digital converters (ADCs) to convert the analog electrical signals from the image sensor into digital data, image signal processors (ISPs) for image enhancement and processing, and other control electronics for functions like autofocus, exposure control, and white balance. In some embodiments, camera module 118 includes high-resolution sensors, infrared (IR) capabilities for night vision, and/or advanced video processing for detection and analytics (which can be located on device 100).

Audio input/output module 120 represents one or multiple devices that provide audio input and/or output capabilities to device 100. Audio input/output module 120 can serve as an external solution for connecting and communicating with audio equipment, thereby offering enhanced audio processing and connectivity options. In some embodiments, audio input/output module 120 features multiple audio input and output ports, such as microphone inputs, line inputs, headphone outputs, and speaker outputs. These ports allow for the connection of various audio devices, such as microphones, instruments, speakers, headphones, or audio mixers. As such, audio input/output module 120 can convert analog audio signals to digital and vice versa. When an audio input device, such as a microphone or instrument, is connected to an input port on audio input/output module 120, the analog audio signals from the device can be converted into digital data. This conversion may be performed by an analog-to-digital converter (ADC). Once the analog audio signals are converted into digital data, audio input/output module 120 can transfer the data to the computer or device via a digital interface, such as USB, Thunderbolt, or FireWire. The digital audio data can then be processed, recorded, mixed, or modified using audio software or applications on device 100. Similarly, for audio output, audio input/output module 120 can receive digital audio data from device 100 and converts it back to analog signals using a digital-to-analog converter (DAC). The analog audio signals are then sent to the output ports of audio input/output module 120, which can be connected to speakers, headphones, or other audio playback devices. As such, audio input/output module 120 can provide high-quality audio input and output capabilities to device 100, which can enable improved audio processing, flexibility, and connectivity options.

Connection mechanism 122 represents connections between device 100 and one or multiple additional devices, such as camera module 118 and audio input/output module 120 shown in FIG. 1. Connection mechanism 122 can be wired or wireless connections and can involve using one or more components of devices 100, such as Ethernet connector 110, camera port 112 and/or audio port 114. In some examples, connection mechanism 122 may be a wired serial bus such as a universal serial bus or a parallel bus. A wired connection may be a proprietary connection as well. Likewise, connection mechanism 122 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, LTE, or 5G), or Zigbee® technology, among other possibilities.

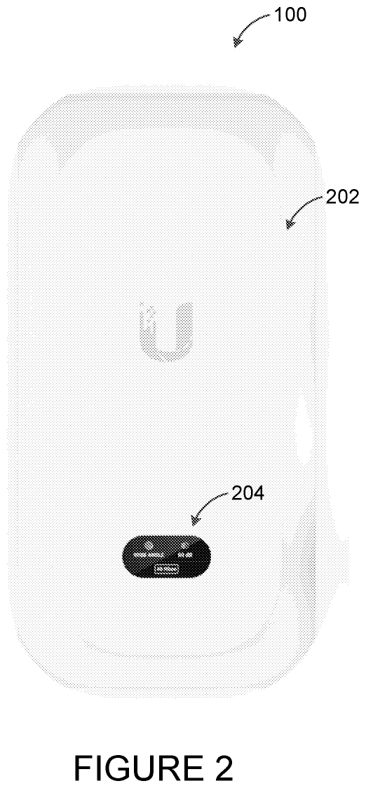

FIG. 2 illustrates front surface 202 of device 100 configured with display screen 204. The example configuration of device 100 shown in FIG. 2 depicts front surface 202 of device 100 with display screen 204 showing information for a user. In particular, display screen 204 is positioned in a middle portion of front surface 202 and shows settings for device 100, such wide angle camera lens is in use, 60 dB sound setting, and 45 Mbps. Display screen 204 can convey various information to a user of device 100 and may differ in size and placement. In some implementations, display screen 204 can be adjusted via one or more user interfaces, such as an application connected to device 100, one or more buttons on device 100, and/or a touch screen interface, among other options.

In some embodiments, display screen 204 is used by device 100 to indicate a variety of information, such as device status and quick actionable feedback when trouble shooting of device 100 may be needed. Device status can convey whether or not device 100 is connected or disconnected to a network, camera module, or audio module, transfer speed, camera type and resolution, speaker type and specifications for the speaker, etc. In some cases, display screen 204 is used for displaying link status, device adopting status, device status after connection to a camera module and/or audio module, system statistics, location of the device, and/or trouble shooting and actionable feedback for the user. System statistics can include options, such as factory reset, restarting, firmware upgrade availability, and/or an option to switch to night mode (e.g., display dimmed lights), which can be set automatically in some examples.

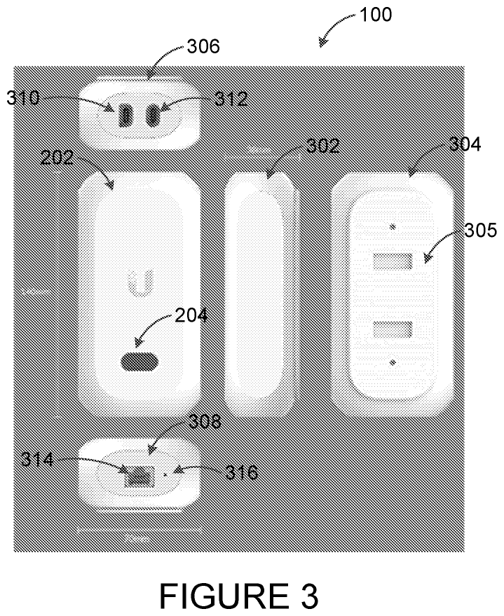

FIG. 3 illustrates various views of the example configuration of device 100. As shown in the example depiction of device 100, the configuration of device 100 can include front surface 202 (as also shown in FIG. 2), side surface 302, back surface 304, top surface 306, and bottom surface 308. The configuration shown in FIG. 3 represents one potential configuration for device 100. As such, other configurations are possible. For instance, the size and/or shape of device 100 can vary in other example configurations.

In the example configuration shown in FIG. 3, bottom surface 308 is shown with Ethernet 314 connector, which can correspond to Ethernet connector 110 shown in FIG. 1. Top surface 306 is shown with camera port 310 and audio port 312, which can correspond to camera port 112 and audio port 114 shown in FIG. 1. Ethernet connector 314 can be configured to provide power and data, thus providing power over Ethernet (POE) to device 100. As such, Ethernet connector 314 is positioned near light 316 that can illuminate one or more colors based on a status of Ethernet connector 314. For instance, light 316 can illuminate green when Ethernet connector 314 is coupled to a LAN via an Ethernet cable and illuminate another color (e.g., red) when the connection is not working. In another example, light 316 can be one or more light emitting diodes (LEDs). One or more LEDs can be positioned on a camera module and/or an audio module and can change state based on the state of the module. For instance, the LED can be off when the module is not powered on, flashing white or another color while the module is initializing, and steady white or another color while waiting for adoption by device 100. The LED can be strobing white when an error is detected, rapid flashing white to convey a factor default, alternating between white and blue when firmware is upgrading, and steady blue when the module is adopted by device 100 and working.

In addition, camera port 310 shown on top surface 306 can be configured to provide power and data to a camera module, as well as facilitate two-way communication between the processor and the camera module. Audio port 312 is configured to provide power and data to at least one audio input/output module, as well as facilitate two-way communication between the processor and the audio module. In some cases, audio port 312 can be configured to provide audio signals to a speaker and receive audio signals from a microphone.

In addition, back surface 304 is shown with coupling mechanism 305, which can be used to connect device 100 to a mount. The configuration and shape of coupling mechanism 305 can vary within example embodiments and can involve using screws, adhesives, or other types of fasteners. Similarly, display screen 204 on front surface 202 can indicate a variety of information based on operations of device 100, such as device status (e.g., connected or disconnected, transfer speed, camera type and resolution of the connected camera module, and/or speaker type or specification of the audio module). Display screen 204 can also provide quick actionable feedback to the user when trouble shooting of device 100 is needed. In some examples, device 100 also includes a USB port and micro SD socket.

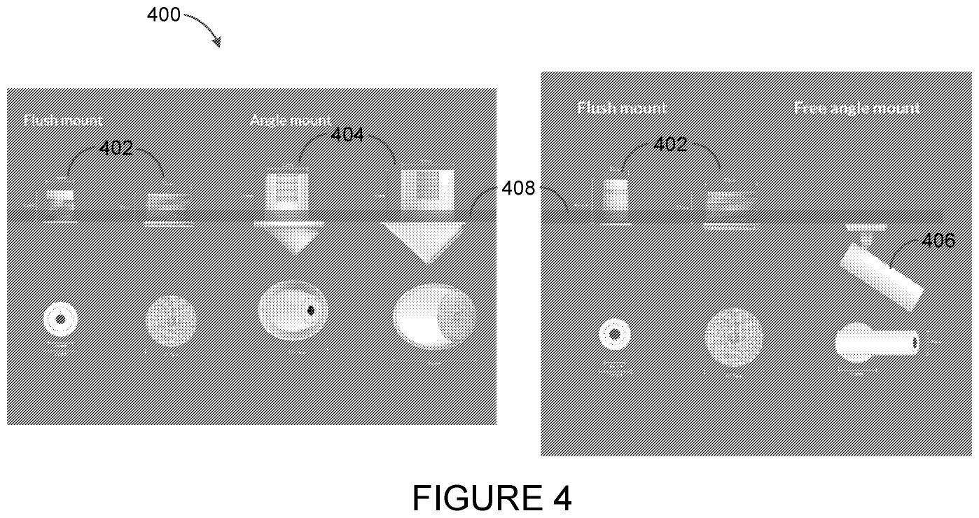

FIG. 4 illustrates camera modules, audio modules, and mounts. In the example embodiment, flush mounts 402, angle mounts 404, and free angle mount 406 are shown mounted relative to ceiling 408 in a cut-away view. Flush mounts 402 position camera modules or audio modules proximate the surface of ceiling 408. As an example result, camera module or audio module can be aligned flush against ceiling 408. Conversely, angle mounts 404 enable camera modules or audio modules to be mounted to ceiling 408 at an angle (e.g., 45 degree angle). The angle mounts 404 enable camera modules or audio modules to be strategically aligned and angled relative to ceiling 408 to focus on a particularly area relative to ceiling 408. Free angle mount 406 is shown coupled to a bottom of ceiling 408 and enables a camera module or audio module to be positioned to focus on a particular angle relative to ceiling 408. In some cases, free angle mount 406 can enable the rotation of the orientation of the camera module and/or audio module. As shown in FIG. 4, the size and shape of the camera module or audio module can differ depending on desired performance.

In some cases, such as when visibility of the device is less desirable, the device can be mounted in a through-wall (or through-ceiling) installation such that only a lens of the camera is visible as represented by flush mounts 402. Alternatively, the device can be mounted using a small mount (e.g., a mount having a low profile protruding from the wall or ceiling). In some cases, the small mount can be an angle mount that keeps the camera module angled at a particular angle (e.g., degrees) and might or might not allow for the camera module to swivel (e.g., angle mounts 404), or the small mount can be a free angle mount that allows the camera module to swivel and move between multiple different angles as represented by free angle mount 406.

Flush mounts 402 and angle mounts 404 enable mounting camera and/or audio modules with a minimal outer footprint. For instance, flush mounts 402 enable a small portion of the speaker or camera (e.g., the lens of the camera) to be mounted against the ceiling, reducing the overall footprint of the camera and/or audio module. The thread designs shown in FIG. 4 enable flush mounts 402, angle mounts 404 to be sandwiched to a ceiling panel or wall with only an outer rim of the camera module or audio module to be exposed. Disclosed mounts also support tape or other structures to be coupled inside the ceiling or wall to enable the camera and/or speaker modules to be robustly secured when the back of ceiling or wall is not accessible.

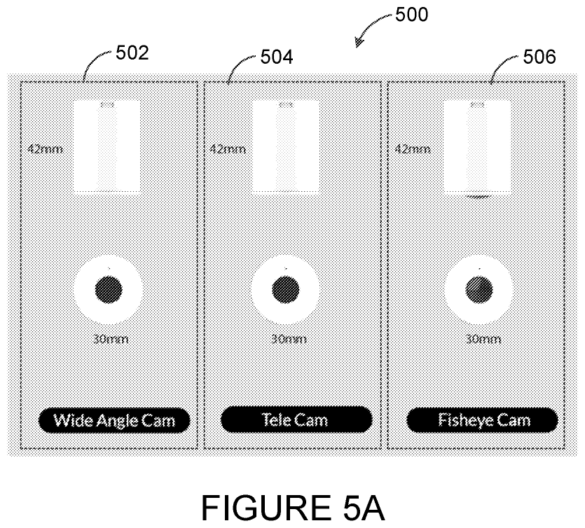

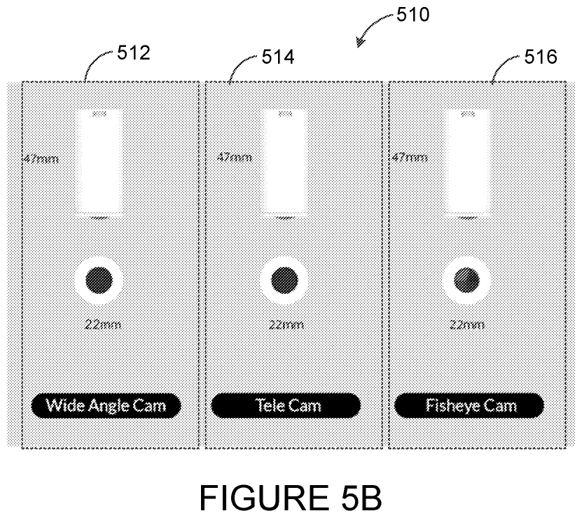

FIG. 5A and FIG. 5B illustrates different types of camera modules that can be used with device 100. As shown, camera modules 500 includes wide-angle camera 502, telephoto camera 504, and fisheye camera 506, among other possibilities. As such, device 100 may determine camera parameters for the different camera modules 500 and adjust operations based on the camera parameters. For instance, upon connection to device 100, processor 102 can determine the camera parameters, which can include the type of camera module, a resolution, field of view, manufacturer, a camera module identification string, and whether the camera module has night vision capabilities, among other possibilities. Settings and operations can be adjusted by device 100 based on one or more camera parameters to increase performance of device.

Wide-angle camera 502 is designed to capture a wider field of view compared to a standard lens and enables capturing more of the scene within the frame. Wide-angle camera 502 have lens with shorter focal lengths (e.g., ranging from 10 mm to 35 mm or wider) and are commonly used in landscape photography, architecture, and situations for capturing a broader perspective. In a mountable camera system, wide-angle camera 502 can be attached to the camera body via a lens mount. The camera system may have a variety of interchangeable lenses to choose from, including wide-angle options, allowing the user to select the lens that best suits their needs.

Telephoto camera 504 is designed to magnify distant subjects and bring them closer. As such, telephoto camera 504 may have lens with longer focal length. Telephoto camera 504 can be used in situations where the camera is used to capture distant subjects without physically getting closer. In a mountable camera system, telephoto camera 504 can be attached to the camera body via a lens mount. The camera system may offer various telephoto lenses with different focal lengths, allowing the user to select the appropriate lens for the desired level of magnification.

Fisheye camera 506 can be used to capture an extremely wide-angle view (e.g., exceeding 180 degrees) and may produce a highly distorted, hemispherical image with a characteristic bulging effect. Fisheye camera lenses are popular for creative and artistic photography, as well as specialized applications. In a mountable camera system, fisheye camera 506 can be attached to the camera body via a lens mount, just like other types of lenses. The camera system may include fisheye lenses of different focal lengths, allowing for different degrees of distortion and coverage.

Incorporating these lenses into a mountable camera system involves providing a lens mount compatible with the specific lens types. The mount should securely hold the lens in place, which ensures proper alignment and communication between the lens and the camera body. The camera system may have an interface for electronically controlling lens functions, such as autofocus and aperture control. By offering a range of interchangeable lenses, the camera system allows adaption to different scenarios with desired visual effects or magnification levels.

FIG. 5B further illustrates different configurations of the types of camera modules 510. As shown, camera modules 510 include wide-angle camera 512, telephoto camera 514, and fisheye camera 516, each having different length and size configurations when compared to camera modules 500 shown in FIG. 5A. In particular, the configurations of camera modules 510 shown in FIG. 5B differ by having 22 mm lens with 47 mm lengths while FIG. 5A shows camera modules 500 having 30 mm lens with 42 mm lengths.

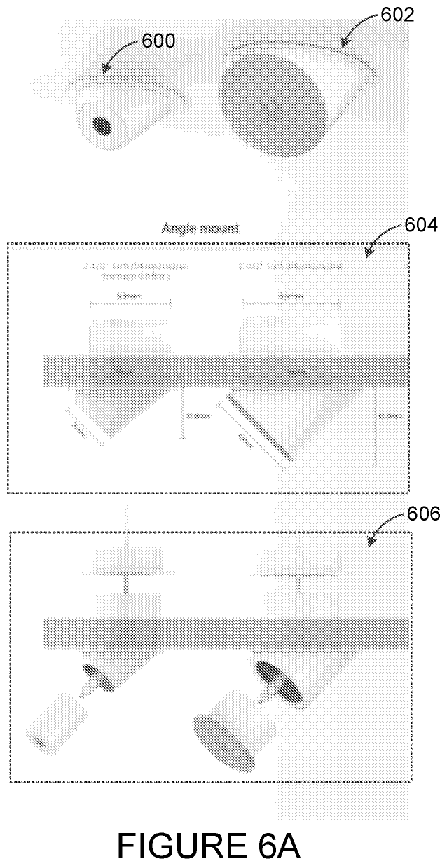

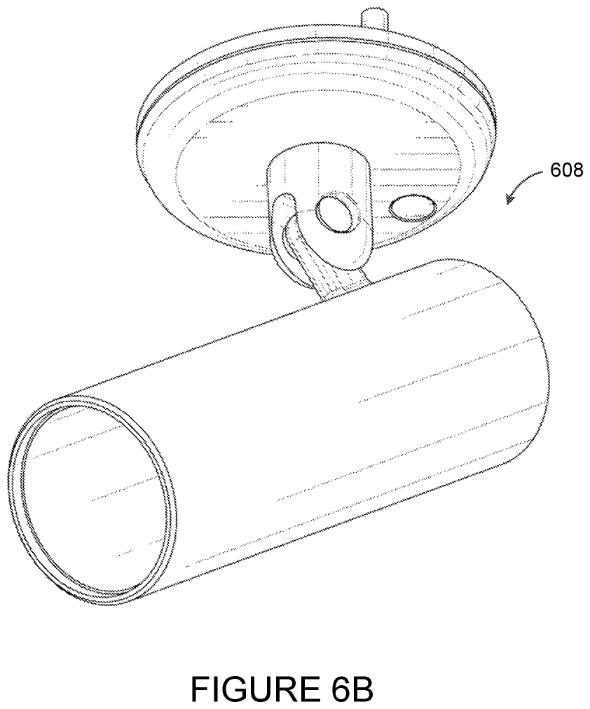

FIG. 6A illustrates camera modules, audio modules, and mounts for such modules, including views depicting how such modules are connected to the mounts. FIG. 6B illustrates camera mount 608 with angle adjustability for use with a camera module, which enables a power cord to be threaded through arm into the camera (or audio module in another example).

As shown in FIGS. 6A, camera module 600 and audio module 602 can be mounted to the ceiling or another surface via a 45-degree ceiling mount. As outlined by box 604, these angle mount enables camera module 600 and audio module 602 to be positioned on a ceiling at a 45-degree angle, thereby allowing camera module 600 and audio module 602 to be focused on a wide field of view while pointing downwards. The angle mounts can consist of two components: a mounting bracket and an adjustable arm as shown in box 606. The mounting bracket is securely attached to the ceiling surface using screws or other suitable fasteners. As such, the mounting bracket provides a stable base for the camera mount. The adjustable arm is connected to the mounting bracket and extends downward at a 45-degree angle. The adjustable arm allows for the positioning of the camera at the desired angle and distance from the ceiling. In some cases, one or more motors can be coupled to the adjustable arm and used to automatically adjust the position or orientation of camera or audio components.

The camera module is attached to the end of the adjustable arm. The mount may include a standard camera mounting plate or bracket that securely holds the camera in place. In addition, the adjustable arm can include a swivel or pivot joint that allows for further angle adjustment. This enables fine-tuning of the camera's positioning to achieve the desired view. By using a 45-degree ceiling camera mount, the camera is positioned to capture a wide area below as it provides an elevated perspective and maximizes the coverage area. In some instances, the mount may have additional adjustments or features, such as cable management systems, pan-and-tilt capabilities, or vandal-resistant construction, to enhance installation convenience and camera functionality. In addition, the mounts can enable cameras and/or audio modules to be extended from the base of the mount. For instance, the mounts can enable camera or audio components within the modules to adjust orientation and/or position relative to the mount.

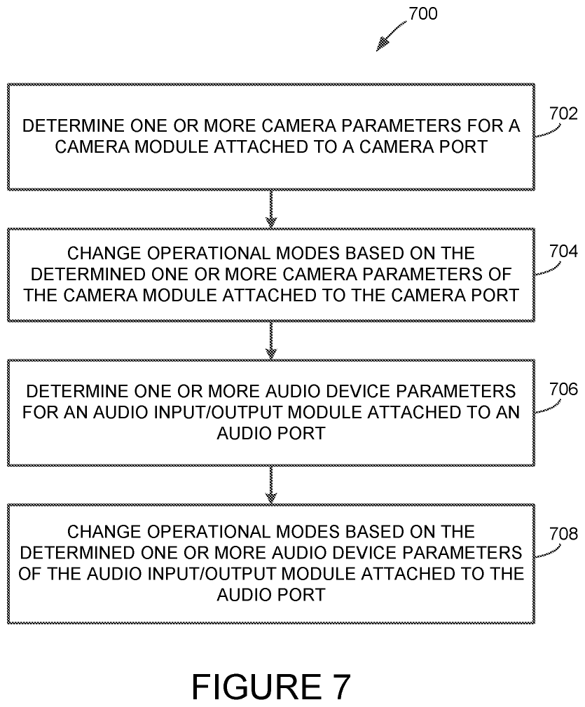

FIG. 7 shows a flowchart of an example method 700. Devices or systems can be used or configured to perform logical functions presented in FIG. 7. For example, device 100 shown in FIG. 1 can perform method 700. In some instances, the device performing method 700 may include an Ethernet connector configured to provide power and data, a camera port configured to provide power and data to a camera module, an audio port configured to provide power and data to at least one audio input/output module, and one or more processors.

At block 702, method 700 involves determining one or more camera parameters for a camera module attached to a camera port. The one or more camera parameters can include a type of a camera module attached to the camera port and a manufacturer of the camera module. The camera port is operable to power a camera module at various distances. For example, the camera port can power a camera module over a distance of 10 meters. In addition, the camera port can include multiple pins. Each pair of four pairs of pins can include a MIPI data bus. The camera port can be a hot swap camera pot with a camera bus and a power line in some examples.

At block 704, method 700 involves changing operational modes based on the determined one or more camera parameters of the camera module attached to the camera port. For example, changing operational modes can involve, based on the determined one or more camera parameters and using mapping data that maps each of a plurality of operational modes of the device to a corresponding respective set of one or more camera parameters, selecting an operational mode that the mapping data maps to the determined one or more camera parameters and performing an action in accordance with the selected operational mode. Each operational mode of the plurality of operational modes can include a mode in which the device operates in accordance with a respective profile, the respective profile defining one or more of a motion detection zone, a person identification zone, or a vehicle detection zone.

At block 706, method 700 involves determining one or more audio device parameters for an audio input/output module attached to an audio port. The one or more audio device parameters can include a type of the audio input/output module attached to the audio port and a manufacturer of the audio input/output module. The audio port can provide audio signals to a speaker and receive audio signals from a microphone. In some examples, the audio port is a hot swap audio port that includes a camera bus and a power line.

At block 708, method 700 involves changing operational modes based on the determined one or more audio device parameters of the audio input/output module attached to the audio port. In some examples, changing operational modes based on the determined one or more audio device parameters involves, based on the determined one or more audio device parameters and using mapping data that maps each of a plurality of operational modes of the device to a corresponding respective set of one or more audio device parameters, selecting an operational mode that the mapping data maps to the determined one or more audio device parameters and performing an action in accordance with the selected operational mode. As such, each operational mode of the plurality of operational modes can include a mode in which the device operates in accordance with a respective profile, the respective profile defining one or more of enabling or disabling a speaker and/or microphone of the audio module, adjusting beamforming capabilities of a speaker and/or microphone, adjusting an output volume of a speaker, adjusting a gain of microphone, adjusting array capabilities of a speaker and/or microphone.

In some examples, the device or system performing method 700 further includes a display screen. As such, the display screen can be used to display information, such as camera information for a camera module coupled to the camera port, a data rate of data communicated from the device by way of the Ethernet connector, a data rate of data communicated from the device by way of the camera module coupled to the camera port, information related to audio captured by a microphone coupled to the audio port, or information related to audio commuted to a speaker by way of the audio port.

In some examples, the device can include additional camera ports. For instance, the device can include a second, third, and fourth camera port for coupling to additional camera modules.

In some examples, the device can further include a through-wall mount configured to facilitate mounting of the device to a wall. For instance, the through-wall mount can include a device-holding portion configured to be disposed within the wall and house at least a portion of the device within the wall such that the device is accessible and visible from an exterior surface of the wall and a support portion configured to attach to an interior of the wall. In some cases, the through-wall mount is configured to facilitate mounting of the device to the wall such that an exterior surface of the device is substantially flush with the exterior surface of the wall.

In some instances, components of the devices and/or systems can be configured to perform the functions such that the components are actually configured and structured (with hardware and/or software) to enable such performance. In other examples, components of the devices and/or systems can be arranged to be adapted to, capable of, or suited for performing the functions, such as when operated in a specific manner. Although blocks in FIG. 7 are illustrated in a sequential order, these blocks can also be performed in parallel, and/or in a different order than those described herein. Also, the various blocks can be combined into fewer blocks, divided into additional blocks, and/or removed based upon the desired implementation.

It should be understood that for these and other processes and methods disclosed herein, flowcharts show functionality and operation of one possible implementation of present examples. In this regard, each block or portions of each block can represent a module, a segment, or a portion of program code, which includes one or more instructions executable by a processor for implementing specific logical functions or steps in the process. The program code can be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium can include non-transitory computer readable medium or memory, for example, such as computer-readable media that stores data for short periods of time like register memory, processor cache and RAM. The computer readable medium can also include non-transitory media, such as secondary or persistent long term storage, like read only memory (ROM), optical or magnetic disks, compact-disc read only memory (CD-ROM), for example. The computer readable media can also be any other volatile or non-volatile storage systems. The computer readable medium can be considered a tangible computer readable storage medium, for example.

In addition, each block or portions of each block in FIG. 6 can represent circuitry that is wired to perform the specific logical functions in the process. Alternative implementations are included within the scope of the examples of the present disclosure in which functions can be executed out of order from that shown or discussed, including substantially concurrent or in reverse order, depending on the functionality involved, as would be understood by those reasonably skilled in the art.

The description of the different advantageous arrangements has been presented for purposes of illustration and description, and is not intended to be exhaustive or limited to the examples in the form disclosed. Many modifications and variations will be apparent to those of ordinary skill in the art. It should be understood that other embodiments can include more or less of each element shown in a given Figure. Further, some of the illustrated elements can be combined or omitted. Yet further, an illustrative embodiment can include elements that are not illustrated in the Figures.

What is claimed is:

1. A device comprising:
an Ethernet connector configured to provide power and data;
a camera port configured to provide power and data to a camera module;
an audio port configured to provide power and data to at least one audio input/output module; and
a processor configured to determine one or more camera parameters for the camera module attached to the camera port, wherein the one or more camera parameters include a type of a camera module attached to the camera port.

2. The device of claim 1, further comprising:
a display screen.

3. The device of claim 2, wherein the display screen is configured to display at least one of:
camera information for a camera module coupled to the camera port, a data rate of data communicated from the device by way of the Ethernet connector, a data rate of data communicated from the device by way of the camera module coupled to the camera port, information related to audio captured by a microphone coupled to the audio port, or information related to audio commuted to a speaker by way of the audio port.

4. The device of claim 1, where the camera port is operable to power a camera module over a distance of 10 meters.

5. The device of claim 1, wherein the camera port comprises a plurality of pins, and each pair of four pairs of pins comprise a MIPI data bus.

6. The device of claim 1, further comprising a second camera port.

7. The device of claim 1, further comprising a second, third, and fourth camera port.

8. The device of claim 1, wherein the one or more camera parameters further include a manufacturer of the camera module.

9. The device of claim 1, wherein the processor is further configured to change operational modes based on the determined one or more camera parameters of the camera module attached to the camera port.

10. The device of claim 9, wherein changing operational modes based on the determined one or more camera parameters of the camera module attached to the camera port comprises:
based on the determined one or more camera parameters and using mapping data that maps each of a plurality of operational modes of the device to a corresponding respective set of one or more camera parameters, selecting an operational mode that the mapping data maps to the determined one or more camera parameters; and
performing an action in accordance with the selected operational mode.

11. The device of claim 10, wherein each operational mode of the plurality of operational modes comprises a mode in which the device operates in accordance with a respective profile, the respective profile defining one or more of: a motion detection zone, a person identification zone, or a vehicle detection zone.

12. The device of claim 1, wherein the processor is further configured to determine one or more audio device parameters for an audio input/output module attached to the audio port, wherein the one or more audio device parameters include a type of an audio input/output module attached to the audio port.

13. The device of claim 12, wherein the one or more audio device parameters further include a manufacturer of the audio input/output module.

14. The device of claim 12, wherein the processor is further configured to change operational modes based on the determined one or more audio device parameters of the audio input/output module attached to the audio port.

15. The device of claim 14, wherein changing operational modes based on the determined one or more audio device parameters of the audio input/output module comprises:
based on the determined one or more audio device parameters and using mapping data that maps each of a plurality of operational modes of the device to a corresponding respective set of one or more audio device parameters, selecting an operational mode that the mapping data maps to the determined one or more audio device parameters; and
performing an action in accordance with the selected operational mode.

16. The device of claim 15, wherein each operational mode of the plurality of operational modes comprises a mode in which the device operates in accordance with a respective profile, the respective profile defining one or more of:
enabling or disabling a speaker and/or microphone of the audio module, adjusting beamforming capabilities of a speaker and/or microphone, adjusting an output volume of a speaker, adjusting a gain of microphone, adjusting array capabilities of a speaker and/or microphone.

17. The device of claim 1, wherein the camera port is a hot swap camera port including a camera bus and a power line.

18. The device of claim 1, wherein the audio port is a hot swap audio port including a camera bus and a power line.

19. The device of claim 1, wherein the audio port is configured to provide audio signals to a speaker and receive audio signals from a microphone.

20. The device of claim 1, further comprising a through-wall mount configured to facilitate mounting of the device to a wall, wherein the through-wall mount comprises (i) a device-holding portion configured to be disposed within the wall and house at least a portion of the device within the wall such that the device is accessible and visible from an exterior surface of the wall and (ii) a support portion configured to attach to an interior of the wall.

21. The device of claim 20, wherein the through-wall mount is configured to facilitate mounting of the device to the wall such that an exterior surface of the device is substantially flush with the exterior surface of the wall.

22. A method comprising:
determining, by a processor coupled to a device, one or more camera parameters for a camera module attached to a camera port, wherein the device includes the camera port configured to provide power and data to the camera module;
changing, by the processor, operational modes based on the determined one or more camera parameters of the camera module attached to the camera port;
determining by the processor, one or more audio device parameters for an audio input/output module attached to an audio port, wherein the device includes the audio port configured to provide power and data to the audio input/output module; and
changing, by the processor, operational modes based on the determined one or more audio device parameters of the audio input/output module attached to the audio port.
